(19) United States
(12) Patent Application Publication
(10) Pub. No.: US 2026/0202010 A1
(43) Pub. Date: Jul. 16, 2026

(54) FIELD SUPPORT DEVICE FOR PORTABLE FIELD EQUIPMENT

(71) Applicant: The Bike Hangar LLC, Shreveport, LA (US)

(72) Inventor: John Squires SMITH, Shreveport, LA (US)

(21) Appl. No.: 19/414,741

(22) Filed: Dec. 10, 2025

Related U.S. Application Data
(60) Provisional application No. 63/730,721, filed on Dec. 11, 2024.

(51) Int. Cl. F16M 13/02

(52) U.S. Cl. CPC F16M 13/022

(57) ABSTRACT

A field support device for portable field equipment includes a clamp, an extendable arm that couples to the clamp, a coupler that couples to the extendable arm, and an equipment mount that couples to the coupler. The field support device provides a single-point clamping rest that removably mounts to a mounting structure having an arbitrary shape and orientation, and provides multi-axis adjustability for the equipment mount.

### STATEMENT OF RELATED CASES

This specification claims priority of US 63/730,721 filed December 11, 2024, and which is incorporated herein by reference.

### FIELD OF THE INVENTION

The present invention relates to an in-the-field support device for stabilizing portable field equipment for use.

### BACKGROUND

Field support devices stabilize portable field equipment for use. Such devices are employed by hunters, wildlife observers, tactical users, and other outdoor professionals to improve the accuracy, control, and/or operational effectiveness of equipment such as firearms, optics, range finders, cameras, sensors, and other outdoor equipment.

Field support devices may be grouped into three categories: (1) freestanding supports such as tripods, bipods, and shooting sticks, (2) passive stabilization aids like beanbags or simple clamp-on cradles, and (3) fixed-position mounts and permanent bolt-on racks designed for use with vehicles, structures, or heavy gear. As discussed further below, existing field support devices are often constrained by their reliance on: particular anchoring configurations to address the surface-specific contact geometry of various mounting structures, a need to engage a mounting structure at multiple locations, a limited range-of-motion, and/or lack of portability.

Freestanding supports, such as tripods, create an independent support structure for the supported equipment, by virtue of the support’s ability to “stand” on the ground. They offer a stable support for firearms, optics, etc., once set up on a stationary surface. Freestanding supports are useful in environments where no natural (e.g., trees, etc.)or fabricated structures are available for support. However, such supports (particularly tripods) have a large footprint when deployed. Moreover, they are not designed to remain fixed when in dynamic or mobile environments. For example, a tripod placed in the bed of a moving vehicle cannot maintain its position or alignment. The usefulness of a freestanding support is therefore limited to static conditions and open terrain; it does not integrate with existing surfaces in a user’s environment.

Passive stabilization aids are primarily intended to stabilize tools on horizontal surfaces; for example, the ledge of a hunting blind or a vehicle door frame. These passive stabilization aids offer basic resting points and some added stability. They are, however, passive in nature, relying on the quality and orientation of existing surfaces. Such passive stabilization aids cannot create new angles for shooting, viewing, etc. In fact, such aids are often used in conjunction with accessories to address the foregoing shortcomings. Furthermore, passive stabilization aids cannot be secured in a manner that maintains position during movement/transit or vibration.

Permanent bolt-on or clamp-on support devices can offer relatively secure support, and may adapt to non-horizontal surfaces such as vehicle frames or blind walls. However, these devices are often designed around specific structures or use cases, requiring distinct attachment methods (e.g., vehicle-/support-structure-specific clamps, bolt-on brackets, adapter plates, etc.). Consequently, they lack flexibility and portability, and are not easily repositionable or transferable between different mounting surfaces. Moreover, many of such devices require custom installation or supplemental hardware, compromising versatility in dynamic field conditions. These devices often incorporate articulated arms that cannot be firmly locked in place, resulting in undesirable movement while in transit. And typically, such devices can be used in a horizontal configuration or a vertical configuration, but not both. Existing devices in this category that do achieve a rigid lock tend to be relatively less compact (i.e., they are large and/or heavy), and suffer drawbacks such as relatively slower setup and reduced flexibility in re-mounting.

Most of the aforementioned field support devices are designed around single-use applications; particularly firearm stabilization, optics mounts, spotting-scope mounts, etc. The traditional tripod is an exception, which provides a platform intended to support a variety of equipment. But, as previously noted, its reliance on stable ground and static environments renders it unsuitable for mobile or multi-surface use.

### SUMMARY

The present invention provides a field support device that avoids many of the disadvantages and drawbacks of the existing field support devices, as described above.

A field support device in accordance with the present teachings provides unprecedented positioning flexibility for the supported equipment, as facilitated by a relatively large number of mechanical rotational degrees of freedom (DOF). Embodiments of a field support device in accordance with the present teachings typically has at least 3 rotational DOFs and one translational DOF. The inventive field support devices described herein are suitable for use with any of a variety of equipment, including, without limitation, firearms, optics, cameras, Starlink^{®} dish, Bluetooth speaker, or lap top computer, subject to an appropriate selection of the equipment mount. Embodiment of the field support device are portable, lightweight, and reconfigurable to accept a variety of equipment mounts for supporting different types of field equipment.

Some embodiments of a field support device include: (i) a clamp, (ii) an extendable arm, (iii) a coupler, and (iv) an equipment mount.

The clamp couples to a mounting structure in the user’s environment. The coupler receives the equipment mount, such as is used to support an item of field equipment. The extendable arm couples the clamp to the coupler, effectively offsetting the mounted piece of field equipment from the mounting structure. In the illustrative embodiment, a first end of the extendable arm is received by the clamp, and the coupler is attached to a second end of the arm.

Clamp. The clamp is capable of detachably coupling to a variety of mounting structures (e.g., a tree/branch, a vehicle, a hunting blind, a bench top, a stationary ledge, a rigid wall panel, etc.) having any of a variety of cross-sections (e.g., circular, polygonal, flat, irregular, etc.) or surface topologies, and in a variety of orientations (vertical, horizontal, angled). And such coupling does not require dedicated mounting hardware or structure- or model-specific fittings; rather, the clamp is “universal” in its applicability. Moreover, use of the clamp does not require any tools; a lever opens and closes the jaws of the clamp.

The clamp includes an arm-receiving interface, which in some embodiments is two openings, each of which is capable of receiving a first end of the extendable arm. These openings are oriented at about ninety degrees with respect to one another. As such, depending upon the opening in which it is received, the extendable arm will have a different orientation with respect to the clamp, and to the mounting structure to which it is clamped. In some other embodiments, the interface is embodied as three or more such openings, supporting additional orientations of the extendable arm.

In some additional embodiments, the arm-receiving interface is a single opening that enables the arm to swivel along an arc of at least ninety degrees, and a pin, etc., which is capable of immobilizing the arm at any angle within the arc of movement. In yet some further embodiments, the arm-receiving interface is two openings, wherein at least one of such openings enables the arm to swivel at least 30 degrees. The aforementioned embodiments of the arm-receiving interface provide one rotational DOF. Additionally, in some embodiments, the arm-receiving interface is embodied as a coupler that provides two or three rotational DOFs, depending upon configuration.

Extendable Arm. In the illustrative embodiment, the length of the extendable arm is adjustable. In some embodiments, this is accomplished via a telescoping arrangement of nesting members, typically embodied as two cylindrical tubes. In some other embodiments, multiple segments can be coupled to one another to adjust the length of the arm. And in yet some further embodiments, arms having a different fixed length may be substituted for one another. In addition to the extendable arm’s translational degree of freedom (DOF) as described above, in some embodiments, it also possesses a rotational DOF. In particular, the extendable arm, or a portion thereof, is capable of rotating about its long axis.

The ability of the extendable arm to translate and rotate enables a user to alter the distance (offset) and orientation of an item of field equipment supported by the field support device relative to the structure to which the clamp is coupled. This capability is further enhanced by the coupler, which may be rotated as necessary with respect to the extendable arm so that the mount may adopt a suitable orientation (i.e., typically, but not necessarily horizontal) regardless of the orientation of the clamp, as dictated by the mounting structure.

The field support device is therefore capable of establishing a new shooting position, etc., independent of the mounting structure’s inherent orientation, configuration, or usability, and ensures sufficient clearance between the mounting surface and supported equipment, so as not to impede its movement. This capability is particularly useful when coupling to a vertically oriented mounting structure.

It is notable, moreover, that in some embodiments, there are no pivot points between the ends of the extendable arm, which would otherwise enable the extendable arm to articulate/bend. For example, in some embodiments, the extendable arm “telescopes” to alter its length. This provides a rigidity/stability as compared to a pivoted arm, particularly if used in a moving vehicle, or if, by virtue of the configuration of the mounting structure, the extendable arm is in a substantially horizontal position, wherein it must resist a downwardly applied force (i.e., the weight of the field equipment). Notwithstanding the rigidity of the extendable arm, the rotational DOFs of other elements of the field support device (i.e., the clamp, coupler, and optionally the equipment support) does not limit spatial adjustability.

Additionally, the extendable arm, in conjunction with the various rotational DOFs of the field support device, facilitates height adjustment of the equipment mount (and hence the supported equipment).

Coupler.In some embodiments, the coupler (which couples the extendable arm to the equipment mount) possesses at least one rotational DOF. Specifically, the coupler (and therefore the attached equipment mount) is free to at least partially rotate about an axis in a plane that is perpendicular to plane in which the extendable arm rotates. For example, in some embodiments, the coupler is embodied as a u-shaped member that is rotatably coupled to the second end of the extendable arm. In some other embodiments, the coupler may be, for example, a ball-head mount, which provides three rotational DOFs. In yet some further embodiments, the coupler provides two DOFs. In embodiments in which the coupler possesses one rotational DOF, the equipment mount itself may provide one or more DOFs, rotational and/or translational.

Equipment mount. The equipment mount is coupled to the coupler. The equipment mount may be readily decoupled from the coupler using a (quick-release) lever (i.e., no external tools are required) to receive a wide variety of equipment mounts. As a function of the equipment mount being fitted, a field support device in accordance with the present teachings therefore has many use cases. For example, the equipment mount may be a v-shaped mount, saddle (gun-vise) mounts, a rifle clamp, a ball mount for a camera, a mount for a Starlink^{®} dish, a mount for a Bluetooth speaker, a standardized mounting interface such as an Arca-Swiss mount or Picatinny rail mount, a Weaver rail, an M-LOK rail, a (second) clamp, a mount for a lap top computer, a mount for an i-Pad^{®}, and the like.

Thus, by virtue of the above-described architecture, embodiments of the field support device provide a rest point for a firearm or other portable field equipment, wherein the rest point is (a) independent of the orientation of the mounting structure, and (b) offset as desired from the mounting structure. Embodiments of the invention are thus capable of using a wide variety of existing structures in the field as a mounting point to create an equipment rest having a desired position and height. And this is accomplished without any specialized adapters, and remains stable in transit. For example, in a hunting scenario, a user may clamp the field support device at a single point to a UTV roof cage, a table, or a grill guard, and achieve a precise, stable rest at a desired height and position. The support remains secure and stationary until detached, ensuring reliability and accuracy during use. And due to its relatively compact size (ca., 14 inches x 6 inches x 2 inches) and light weight (ca., 2.3 pounds), the present field support device is readily portable.

Embodiments of the field support device thus provide a single-point clamping rest that removably mounts to a mounting structure having an arbitrary shape and orientation, and provides multi-axis adjustability of equipment mount.

In some embodiments, the invention provides a field support device for portable field equipment including:

a clamp, wherein the clamp provides at least one rotational degree of freedom;

an extendable arm having a first end and a second end, wherein the first end of the extendable arm is coupled to the clamp, the extendable arm providing one rotational degree of freedom and one translational degree of freedom;

a coupler that is coupled to the second end of the extendable arm, the coupler providing at least one rotational degree of freedom; and

an equipment mount that is coupled to the coupler.

In some further embodiments, the invention provides a field support device for portable field equipment including:

a clamp, wherein the clamp includes two openings disposed orthogonally to one another;

an extendable arm having a long axis and including a first member having a first length and a second member having a second length, the first member and the second member maintaining a coaxial relationship to one another, wherein a first end of the first member is received by one of the two openings in the clamp, the first member being immobilized thereby, and wherein the second member is dimensioned and arranged to fit within the first member and move along the long axis and rotate about the long axis;

a coupler that is coupled to a second end of the second member, the coupler rotatable about an axis that is orthogonal to the long axis; and

a v-shaped mount, wherein the v-shaped mount is coupled to the coupler.

In yet some additional embodiments, the provides a field support device for portable field equipment including:

a clamp for removably attaching to a mounting structure via a quick-release lever, the clamp physically adapted to receive, in more than one orientation relative to the clamp, a first end of an extendable arm;

the extendable arm coupled to the clamp, the extendable arm having an adjustable length and characterized by a long axis, wherein at least a portion of the extendable arm is rotatable about the long axis;

a coupler that is coupled to a second end of the extendable arm, the coupler rotatable about an axis that is orthogonal to the long axis;

and an equipment mount, wherein the equipment mount is coupled to the coupler.

Additional embodiments are illustrated in appended drawings and described in the Detailed Description below.

### BRIEF DESCRIPTION OF THE DRAWINGS

FIG. 1 depicts a field support device in accordance with an illustrative embodiment of the present invention.

FIG. 2A depicts a side view of a first embodiment of a clamp for use in conjunction with the field support device of FIG. 1.

FIG. 2B depicts a perspective view of the clamp of FIG. 2A.

FIG. 2C depicts the clamp of FIG. 2A with a jaw insert.

FIG. 2D depicts a perspective view of a first alternative embodiment of a clamp for use in conjunction with the field support device of FIG. 1.

FIGS. 2E and 2F depict perspective views of a second alternative embodiment of a clamp for use in conjunction with the field support device of FIG. 1.

FIG. 2G depicts a perspective view of a third alternative embodiment of a clamp for use in conjunction with the field support device of FIG. 1

FIG. 3A depicts an exploded view of an extendable arm for use in conjunction with the field support device of FIG. 1.

FIG. 3B depicts a perspective, exploded view of the extendable arm of FIG. 3A, and a coupler for use in conjunction with the field support device of FIG. 1.

FIG. 4A depicts a perspective view of an embodiment of a field support device incorporating a v-shaped equipment mount, wherein the field support device is in a first configuration.

FIG. 4B depicts a perspective view of the field support device of FIG. 4A, but in a second configuration.

FIG. 4C depicts an alternative embodiment of a coupler for use with a v-shaped equipment mount.

FIG. 5 depicts a v-shaped mount that includes a firearm strap.

FIG. 6 depicts an Arca Swiss-Compatible mount for use with a field support device in accordance with the present teachings.

FIG. 7 depicts a saddle mount for use with a field support device in accordance with the present teachings.

FIG. 8 depicts a plate mount for use with a field support device in accordance with the present teachings.

FIG. 9 depicts a field support device that includes an equipment mount for retaining fishing rods.

FIG. 10 depicts a field support device that includes an equipment mount for retaining firearms.

FIG. 11 depicts an alternative embodiment of a field support device.

### DETAILED DESCRPTION

The following description illustrates the principles of the disclosure. It will therefore be appreciated that those skilled in the art will be able to devise various arrangements which, although not explicitly described or shown herein, embody the principles of the disclosure and are included within its spirit and scope.

Furthermore, all examples and conditional language recited herein are principally intended for pedagogical purposes to aid the reader in understanding the principles of the disclosure and the concepts contributed by the inventors to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

The following terms are defined for use in this Specification, including the appended claims: "Aboutand "substantiallyand “ca” mean +/- 20% of a stated nominal size, quantity, etc.

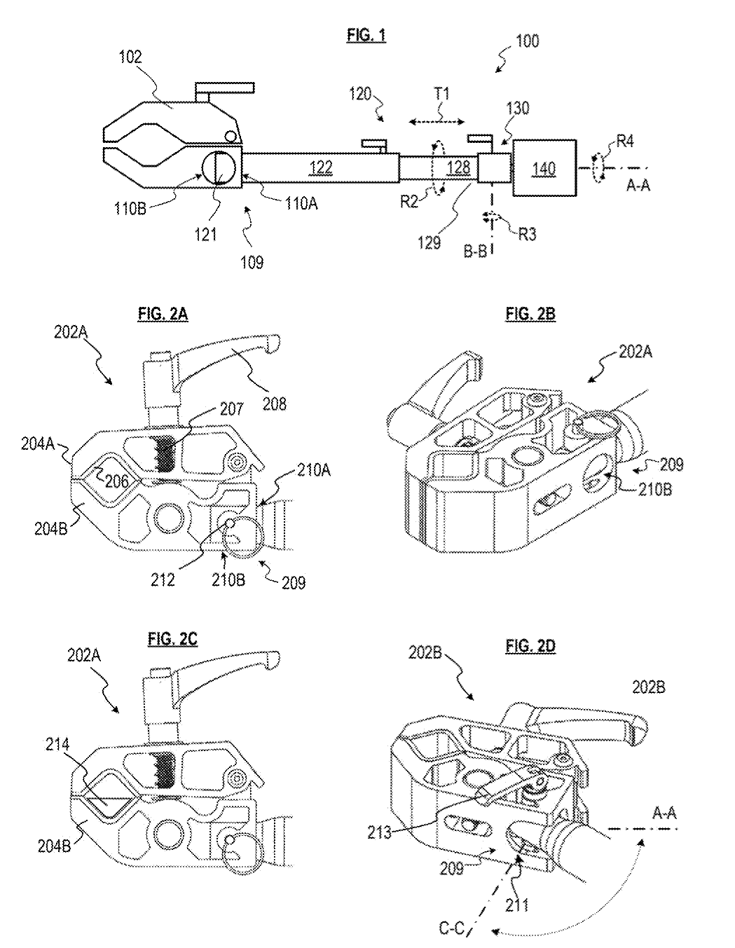

FIG. 1 depicts field support device (“FSD”) 100 in accordance with an illustrative embodiment of the present invention. FSD 100 includes clamp 102, extendable arm 120, coupler 130, and equipment mount 140.

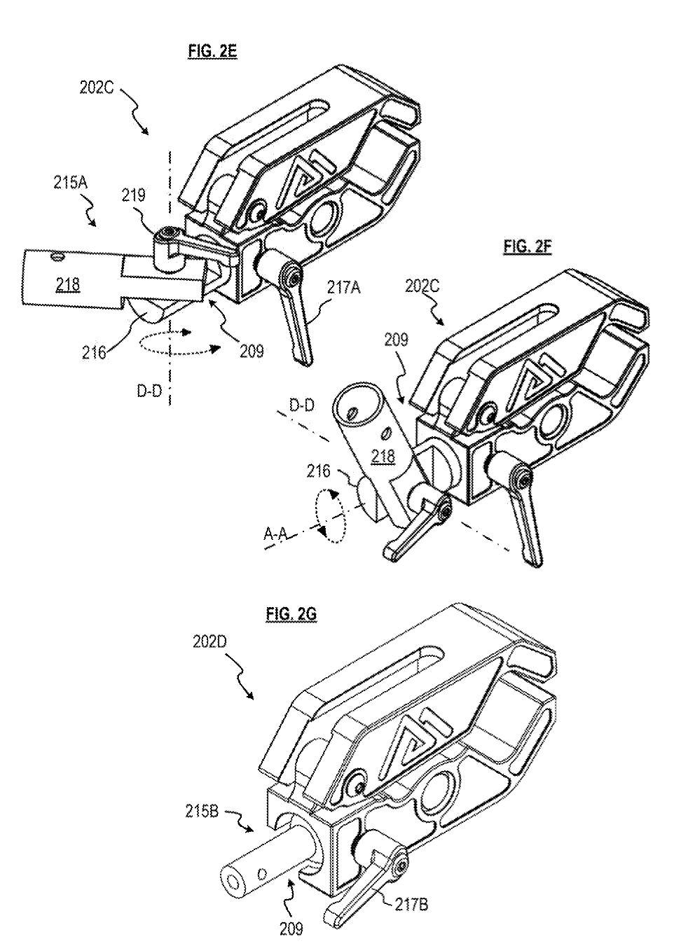

Clamp 102, which clamps to a mounting structure when in use, receives first end 121 of extendable arm 120 in a first opening 110A. A second opening —opening 110B— is oriented at ninety degrees with respect to opening 110B and is alternatively capable of receiving first end 121 of extendable arm 120. First opening 110A and second opening 110B are an exemplary embodiment of arm-receiving interface 109 of clamp 102. The ability of clamp 102 to receive extendable arm 120 in either of two opening 110A and 110B provides a first rotational DOF to FSD 100. Clamp 102 is described in further detail below in conjunction with FIGS. 2A-2G, which illustrate, among other features, further embodiments of the clamp’s arm-receiving interface.

In FIG.1, extendable arm 120 comprises two cylindrical members or sleeves: member 122 and member 128. In the illustrative embodiment the members nest; that is, relatively smaller-diameter member 128 nests within relatively larger-diameter member 122. Member 122 is rigidly (although removably) fixed to clamp 102, whereas member 128 is movable; in particular, it is capable of translational and rotational movement with respect to member 122. In this embodiment, member 128 is capable of sliding/translating along long axis A-A of extendable arm 120 (in telescoping fashion) providing a first translational DOF (T1) to FSD 100. And member 128 is also capable of rotating relative to member 122 about axis A-A, providing a second rotational DOF (R2) for FSD 100.

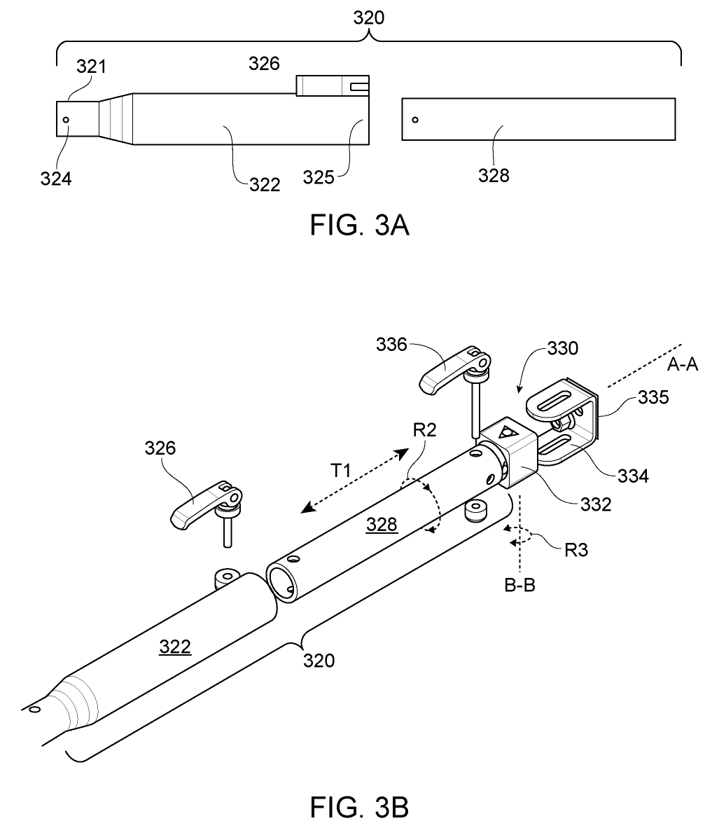

In this embodiment, member 122 defines the minimum length of extendable arm 120 (i.e., when member 128 is substantially fully nested within member 122). To increase the length of extendable arm 120, movable member 128 is partially withdrawn from member 128 (translating to the “right” in FIG. 1). Further disclosure concerning extendable arm 120 is provided in FIGS. 3A-3B and the accompanying description.

Second end 129 of extendable arm 120 is attached to coupler 130. In the illustrative embodiment depicted in FIG. 1, coupler 130 is capable of rotating with respect to extendable arm 120 about axis B-B, which is orthogonal to long axis A-A of extendable arm 120. This embodiment of coupler 130 therefore provides a third rotational DOF (R3) to FSD 100. Further disclosure concerning coupler 130 is provided later in this specification.

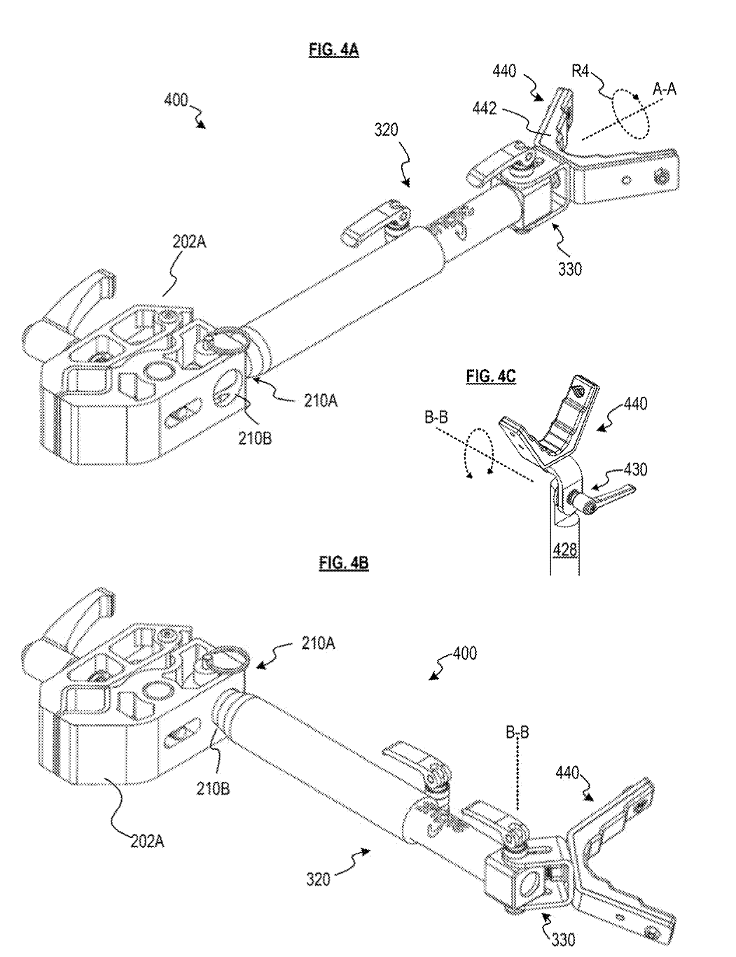

Any of a variety of equipment mounts 140 may be coupled to coupler 130. Exemplary equipment mounts are disclosed in FIGS. 4A-4C and 5-10.

FIGS. 2A and 2B depict respective side and perspective views of clamp 202A, which is a specific embodiment of clamp 102 of FIG. 1, and which may be used in conjunction with embodiments of the invention. Clamp 202A includes upper jaw 204A, lower jaw 204B, jaw inserts 206, clamp spring 207, handle/threaded rod 208, and arm-receiving interface 209.

In some embodiments, the jaws of clamp 202A accommodate objects having a circular/oval cross section in a range of diameter between about 0.5 to 2.5 inches, objects having a square/rectangular cross section in a range of thickness between about 0.5 to 2.7 inches, and flat objects having a thickness up to 2.7 inches. Jaw inserts 206 provide a polymer or rubber surface that is non-marring, durable, and has an excellent grip for coupling to a mounting structure. In some embodiments, jaw inserts 206 comprise thermoplastic polyurethane (TPU). In some other embodiments, jaw inserts 206 have a different surface profile, such as to complements the surface texture, etc., of a particular mounting structure, so as to improve grip. A user may readily exchange versions of jaw inserts 206 in the field, by simply “popping” out one version and inserting another.

In clamp 202A, arm-receiving interface 209 includes two arm-receiving openings 210A and 210B, which are disposed orthogonally to one another. Depending on the orientation of the mounting surface, one or the other of the arm-receiving openings may be preferred. Pull pin 212 secures first end of extendable arm to clamp 202A. In particular, FIGS. 2A-2D depict the end of one of the members of the extendable arm inserted into an arm-receiving opening; pull pin 212 secures the member. Pull pin 212 is readily removable, such as to withdraw the extendable arm from opening 210A and then insert it into 210B.

With the exception of handle 208 and jaw inserts 206, clamp 202A comprises metal, such aluminum, which is preferred for its light weight. Clamp 202A is machined and then anodized (assuming the material of construction is a non-ferrous metal).

FIG. 2C depicts clamp 202A with flat-mount insert 214 positioned in lower jaw 204B. Flat-mount insert 214 functions as a “shim” for objects that are smaller than about 1 inch, and also provides an improved grip when gripping to flat mounting surfaces. As a function of use case (e.g., different clamp mounting orientations, etc.), flat-mount insert 214 can alternatively be positioned in upper jaw 204A.

FIG. 2D depicts clamp 202B. Whereas arm-receiving interface 209 of clamp 202A is two arm-receiving openings 210A and 210B, that of clamp 202B is a single arm-receiving opening 211 that is physically adapted to enable the extendable arm to partially rotate through an arc of about ninety degrees between axis A-A and axis C-C. Extendable arm 120 may be fixed at any angle within the arc-of-movement via handle 213. In some other embodiments, the arc-of-movement may be greater than ninety degrees. Use of either clamp 202A or clamp 202B in FSD 100 provides one rotational DOF.

FIGS. 2E and 2F depict clamp 202C. For clarity, some features of clamp 202C, such as the clamp spring, handle, etc. are not depicted. Rather than implementing arm-receiving interface 209 as simple opening(s), in clamp 202C, arm-receiving interface is embodied as coupler 215A. This coupler includes first portion 216, which extends into clamp 202C through an opening, and second portion 218 that rotatably couples to first portion 216. Second portion 218 includes an opening for receiving the first end of the expandable arm. First portion 216 is free to rotate 360 degrees about axis A-A, and is immobilized via handle 217A, and second portion 218 is capable of partially rotating relative to first portion 216 about axis D-D, and is immobilized in a desired orientation via handle 219. Clamp 202C thus imparts two rotational DOFs to an FSD in accordance with the present teachings.

FIG. 2G depicts clamp 202D. In this clamp, arm-receiving interface 209 is embodied as ball-mount coupler 215B. The end of extendable arm 120 attaches to the tubular portion of coupler 215B. Clamp 202D imparts 3 rotational DOFs to an FSD in accordance with the present invention. Handle 217B immobilizes coupler 215B.

It is notable that all embodiments, configuring and operating the clamp is “tool-free.” That is, the relatively large handle 208 (see FIG. 2A) that adjusts the jaws of the clamp is manipulated by hand; no bolts, etc. are required to couple the clamp to a mounting structure. And to the extent it is desirable to relocate the expandable arm from one arm-receiving opening to another in clamp 202A (such as to accommodate a change in the orientation of a mounting structure when moving the clamp from one mounting structure to another), that simply requires removable and re-insertion of a pull pin.

FIGS. 3A and 3B depict respective top-side and perspective “exploded” views of extendable arm 320, which is a specific embodiment of extendable arm 120 of FIG. 1, and which may be used in conjunction with embodiments of the invention.

Extendable arm 320 includes two elongate members: member 322 and member 328. In the illustrative embodiment, these members are cylindrical, and member 328 is sized to fit within member 322. First end 321 of member 322 is tapered and sized to couple to the clamp (i.e., clamp 202A, 202B, 202C, or 202D). Hole 324 near end 321 of member 322 receives a pin (e.g., see FIG. 2A: pin 212) to securely couple that member to the clamp. A longitudinal slit (not depicted) that extends for about one inch inward along the length of member 322 from end 325 thereof enables that member to be clamped down, via handle 326, applying pressure to nested member 328 to immobilize it at a desired position and orientation.

As depicted in FIG. 3B, member 328 is capable of translating along long axis A-A of expandable arm 320, thereby providing translational DOF T1 to an FSD in accordance with the invention. Member 328 is also capable of rotating relative to member 322 about axis A-A, providing rotational DOF R2 for an FSD in accordance with the invention. It is notable that extendable arm 320 is not pivoted or jointed along its length; that is, it cannot bend (other than any minimal flex that may occur if equipment being supported by the equipment mount is heavy).

The minimum offset or extension provided by extendable arm 320 (relative to the clamp) is substantially equal to the length of member 322. In such embodiments, member 328 is substantially fully nested within member 322. At maximum offset or extension of extendable arm 320 (relative to the clamp), member 328 extends from member 322 by about one-half to three-fourths of the length of member 328. For example, in some embodiments, member 322 and member 328 each have a length of about 6 inches. In such embodiments, the minimum offset or extension is about 6 inches and the maximum offset is in the range of about 9 to 10.5 inches (i.e., 6 + (0.5 x 6) or (0.75 x 6)). In some other embodiments, member 322 is longer than 6 inches, such as up to about 12 inches. In some further embodiments, member 328 is longer than 6 inches, such as up to about 12 inches. In yet some additional embodiments, both members 322 and 328 are longer than 6 inches, such as up to about 12 inches. Moreover, in some embodiments, extendable arm 320 includes a third member (not depicted), such that both the second and third member are translatable and/or rotatable.

FIG. 3B also depicts coupler 330, which is an embodiment of coupler 130 of FIG. 1. Coupler 330 includes cap 332 and u-shaped bracket 334, which are coupled to end 329 of member 328 via handle/screw 336. U-shaped bracket 334 is rotatably coupled to cap 332, such that u-shaped bracket 334 is able to partially rotate about axis B-B, providing third rotational DOF (R3) for an FSD in accordance with the invention. An equipment mount (not depicted in FIG. 3B), couples to surface 335 of u-shaped bracket 334.

Members 322 and 328 of expandable arm 320 comprise metal, such as aluminum, which is preferred for its light weight, and which is anodized. Coupler 330 is also formed of metal, such as anodized aluminum.

FIGS. 4A and 4B depict perspective views of FSD 400, which is a specific embodiment of FSD 100 of FIG. 1. FSD 400 includes clamp 202A, extendable arm 320, coupler 220, and v-shaped rest 440. In FIG. 4A, extendable arm 320 is received by opening 210A, and in FIG. 4B, extendable arm 320 is received by opening 210B.

V-shaped rest 440 is one of many equipment supports that may be used in conjunction with an FSD in accordance with the present teachings. In the illustrative embodiment, v-shaped rest 440 is rotatably coupled to coupler 330, such that rest 440 is capable of rotating 360 degrees about axis A-A, providing fourth rotational DOF (R4) to FSD 400. Insert 442 provides a polymer or rubber surface that is non-marring, durable, and has excellent grip. In some embodiments, insert 442 comprises thermoplastic polyurethane (TPU). V-shaped rest 440 is typically used to cradle the end of a rifle, providing a single point of contact. The ability of v-shaped rest 440 to rotate relative to coupler 330 provides a “swivel” capability. Thus, the single point of contact is “on” a swivel, functioning as turret. That is, supported in such fashion via v-shaped rest 440, a supported weapon can track a target horizontally without having to adjust clamp 202A.

As noted above, in FIG. 4B, FSD 400 has a different configuration than in FIG. 4A. In particular, in FIG. 4B, extendable arm 320 is received by opening 210B and coupler 330 is depicted as being partially rotated about axis B-B. FSD 400 possesses five DOFs: (i.e., clamp 202A: one rotational, extendable arm 320: one rotational and one translational, coupler 330: one rotational, v-shaped rest 440: one rotational).

FIG. 4C depicts an alternative embodiment of FSD 400, wherein member 328 of expandable arm 320 is modified to provide end 429, which is configured to receive coupler 430. Coupler 430 is capable of partially rotating about axis B-B. Like coupler 330, coupler 430 provides one rotational DOF.

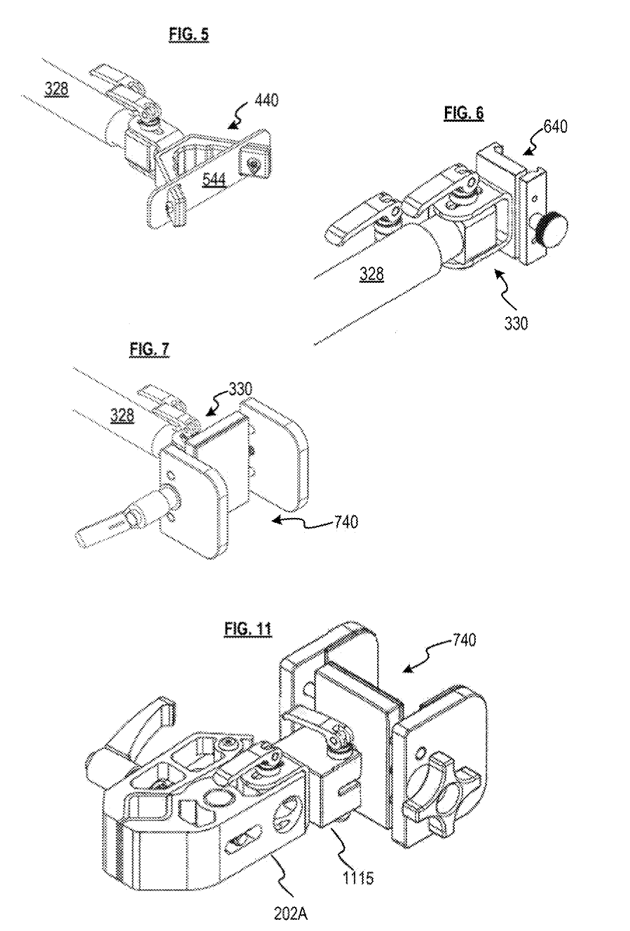

FIGS. 5-8 depict several different equipment mounts, familiar to those skilled in art, for use in conjunction with embodiments of the invention. For conciseness, these figures only depict the equipment mount, a coupler, and the end of extendable member 320 (i.e., a portion of member 328).

FIG. 5 depicts firearm strap 544 in use with v-shaped rest 440. Firearm strap 444 restrains the end of the firearm (not depicted) that is supported on v-shaped rest 440.

FIG. 6 depicts plate mount 640, such as provided by Arca-Swiss company. FIG. 6 depicts plate mount 640 coupled to coupler 330. FIG. 6 provides an example of using a standardized mounting interface in conjunction with an FSD in accordance with the present invention. Other non-limiting examples of a standardized mounting interface suitable for use in embodiments of the invention include a Picatinny rail (military standard mounting interface for firearm accessories), a Weaver rail, an M-LOK rail. FIG. 7 depicts saddle mount 740.

FIG. 8 depicts plate mount 840, coupled to coupler 930. Plate mount 840 may be used to support a lap top, i-Pad^{®} or like device. Coupler 930 includes first member 932 and second member 934. The second member 934 is rotatably coupled to first member 932. First member 932 functions in the same manner as coupler 430, facilitating rotation about the depicted axis, providing rotational DOF R3. Second member 934 enables a “yaw” type of rotation, providing rotational DOF R4. These rotations are in orthogonal planes; the same as depicted in FIG. 1.

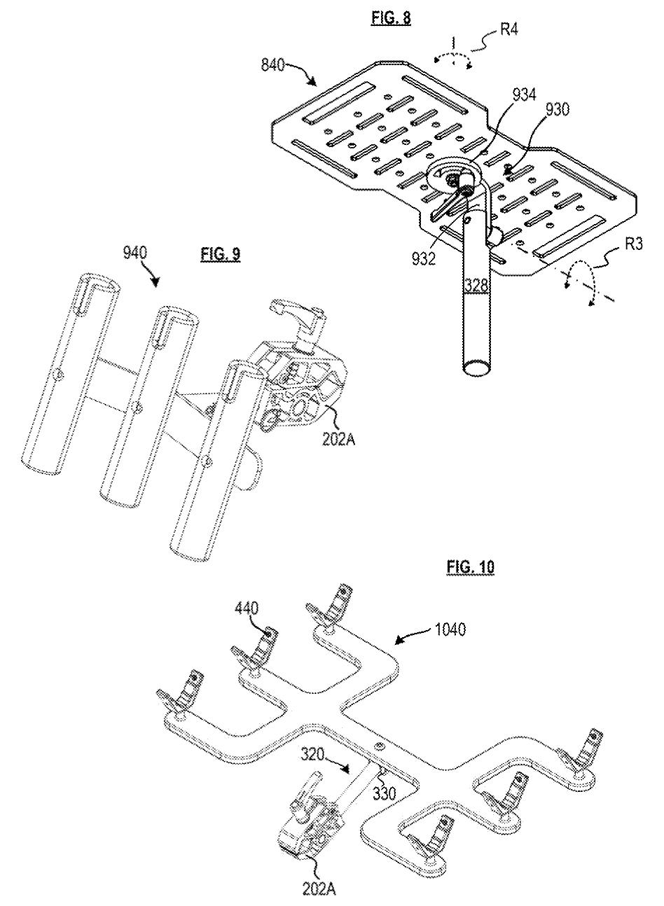

FIGS. 9 and 10 depict embodiments in which the field support device is primarily intended for storage and/or transport of portable field equipment. FIG. 9 depicts FSD 900, which includes clamp 202A, extendable arm 320, a coupler (not depicted), and fishing-rod support 940. FIG. 10 depicts FSD 1000, which includes clamp 202A, extendable arm 320, coupler 330, and firearm support 1040, which includes 3 pairs of v-shaped rests 440, each pair having two v-shaped rests 440 spaced apart to support a rifle. Since this embodiment is primarily intended for storage, each v-shaped rest 440 is used in conjunction with a firearm strap, such as firearm strap 544 depicted in FIG. 5. In another embodiment (not depicted), in which the field support device is primarily intended for transportation/storage of portable field equipment, the equipment support is a clamp, which may be identical to the clamp that couples to the mounting structure.

FIG. 11 depicts FSD 1100 in accordance with an alternative embodiment of the present invention. In this embodiment, the FSD include clamp 202A, ball mount coupler 1115, and an equipment mount. In this embodiment, the equipment is saddle mount 740. FSD 1100 may be used in scenarios when there is no need to provide an offset between the mounting structure and the equipment being supported. Ball mount coupler 1115 is used since it provides three rotational DOFs. Since clamp 202A has two arm-receiving holes, FSD 1000 provides four rotational DOFs.

What is claimed:

1. A field support device for portable field equipment comprising:
a clamp, wherein the clamp provides at least one rotational degree of freedom;
an extendable arm having a first end and a second end, wherein the first end of the extendable arm is coupled to the clamp, the extendable arm providing one rotational degree of freedom and one translational degree of freedom;
a coupler that is coupled to the second end of the extendable arm, the coupler providing at least one rotational degree of freedom; and
an equipment mount that is coupled to the coupler.

2. The field support device of claim 1 wherein the clamp includes two openings disposed orthogonally to one another, and wherein one of two openings receives the first end of the extendable arm.

3. The field support device of claim 1 wherein the clamp includes an opening for receiving the extendable arm, wherein the opening is dimensioned and configured to enable the extendable arm to swivel through an arc of at least ninety degrees.

4. The field support device of claim 1 wherein the clamp receives a flat-mount insert in one of the upper or lower jaws thereof, the flat-mount insert functioning to enable the clamp to securely couple to a mounting structure having dimensions too small to be secured by the clamp in the absence of the flat-mount insert, or to improve a grip when clamping to a flat mounting structure.

5. The field support device of claim 1 wherein the equipment mount is selected from the group consisting of a v-shaped mount, a saddle mount, and a standardized mounting interface.

6. The field support device of claim 1 wherein the equipment mount provides at least one rotational degree of freedom.

7. The field support device of claim 1 wherein the clamp provides two, and only two rotational degrees of freedom.

8. The field support device of claim 1 wherein the clamp provides three, and only three rotational degrees of freedom.

9. The field support device of claim 1 wherein clamp provides at least two rotational degrees of freedom.

10. The field support device of claim 1 wherein the coupler provides at least two rotational degrees of freedom.

11. The field support device of claim 1 wherein the extendable arm has a long axis, and includes a first cylindrical member that couples to the clamp, and a second cylindrical member, wherein the second cylindrical member is sized to fit within the first cylindrical member and move along the long axis thereof and rotate about the long axis thereof.

12. The field support device of claim 2 wherein the extendable arm includes a first cylindrical member and a second cylindrical member, wherein one of two openings receives the first cylindrical member thereby preventing any movement thereof, wherein the second cylindrical member is sized to fit within the first cylindrical member and move along a long axis thereof, a length of the extendable arm therefore being adjustable.

13. The field support device of claim 1 wherein the extendable arm has a first member and a second member that maintain a coaxial relationship to one another, wherein the first member couples to the clamp and is immobilized thereby, and the second member is translatable and rotatable with respect to the first member.

14. The field support device of claim 1 wherein the extendable arm is not jointed.

15. A field support device for portable field equipment comprising:
a clamp, wherein the clamp includes two openings disposed orthogonally to one another;
an extendable arm having a long axis and including a first member having a first length and a second member having a second length, the first member and the second member maintaining a coaxial relationship to one another, wherein a first end of the first member is received by one of the two openings in the clamp, the first member being immobilized thereby, and wherein the second member is dimensioned and arranged to fit within the first member and move along the long axis and rotate about the long axis;
a coupler that is coupled to a second end of the second member, the coupler rotatable about an axis that is orthogonal to the long axis; and
a v-shaped mount, wherein the v-shaped mount is coupled to the coupler.

16. The field support device of claim 15 wherein a length of the extendable arm has a minimum length that is substantially equal to the first length of the first member, and a maximum length that equal to first length plus at least one half of the second length of the second member.

17. The field support device of claim 15 wherein the v-shaped mount is rotatably coupled to the coupler.

18. The field support device of claim 15 wherein the field support device weighs about 2.3 pounds.

19. A field support device for portable field equipment comprising:
a clamp for removably attaching to a mounting structure via a quick-release lever, the clamp physically adapted to receive, in more than one orientation relative to the clamp, a first end of an extendable arm;
the extendable arm coupled to the clamp, the extendable arm having an adjustable length and characterized by a long axis, wherein at least a portion of the extendable arm is rotatable about the long axis;
a coupler that is coupled to a second end of the extendable arm, the coupler rotatable about an axis that is orthogonal to the long axis; and
an equipment mount, wherein the equipment mount is coupled to the coupler.

20. The field support device of claim 19 wherein the extendable arm consists of first and second cylindrical members that maintain a coaxial orientation with respect to one another, wherein the first cylindrical member is coupled to the clamp and is immobilized thereby, and the second cylindrical member at least partially nests within the first cylindrical member and is movable along the long axis and is rotatable about the long axis.
